(19) United States
(12) Patent Application Publication
(10) Pub. No.: US 2023/0281597 A1
(43) Pub. Date: Sep. 7, 2023

(54) SYSTEMS AND METHODS FOR PROXIMITY-BASED MOBILE DEVICE PERSON-TO-PERSON PAYMENTS

(71) Applicant: JPMORGAN CHASE BANK, N.A., New York, NY (US)

(72) Inventors: Samuel BROSEN, New York, NY (US); Sonny KUNG, Flushing, NY (US); Julie KIMMERLING, Brooklyn, NY (US); Christy LILLIE, New York, NY (US)

(21) Appl. No.: 18/178,291

(22) Filed: Mar. 3, 2023

Related U.S. Application Data
(60) Provisional application No. 63/268,909, filed on Mar. 4, 2022.

(51) Int. Cl. G06Q 20/32; G06Q 20/40; G06Q 20/26

(52) U.S. Cl. CPC G06Q 20/327; G06Q 20/4014; G06Q 20/26

(57) ABSTRACT

System and methods for proximity-based mobile device person-to-person payments are disclosed. In one embodiment, a method for proximity-based mobile device person-to-person payments may include: (1) receiving, at a payment recipient computer application executed on a payment receiving mobile device, a requested payment amount for a payment from a payment recipient from a payment sender; (2) causing, by the payment recipient computer application, the payment receiving mobile device to enter a listening mode; (3) receiving, by the payment recipient computer application, a communication from a payment sender computer application executed by a payment sending mobile device; (4) wirelessly communicating, by the payment recipient computer application, the requested payment amount to the payment sender computer application; (5) wirelessly receiving, by the payment recipient computer application and from the payment sender computer application, payment information; and (6) executing, by the payment recipient computer application, the payment using the payment information.

### RELATED APPLICATIONS

This application claims priority to, and the benefit of, U.S. Provisional Patent Application Ser. No. 63/268,909, filed Mar. 4, 2022, the disclosure of which is hereby incorporated, by reference, in its entirety.

### BACKGROUND OF THE INVENTION

### 1. Field of the Invention

Embodiments generally relate to systems and methods for proximity-based mobile device person-to-person payments.

### 2. Description of the Related Art

Mobile devices, such as smartphones and smart watches have revolutionized the manner in which people can make payments. Using their mobile devices, people can pay for goods or services without having to present a credit card, write a check, or hand over cash.

### SUMMARY OF THE INVENTION

Systems and methods for proximity-based mobile device person-to-person payments are disclosed. In one embodiment, a method for proximity-based mobile device person-to-person payments may include: (1) receiving, at a payment recipient computer application executed on a payment receiving mobile device, a requested payment amount for a payment from a payment recipient from a payment sender; (2) causing, by the payment recipient computer application, the payment receiving mobile device to enter a listening mode; (3) receiving, by the payment recipient computer application, a communication from a payment sender computer application executed by a payment sending mobile device; (4) wirelessly communicating, by the payment recipient computer application, the requested payment amount to the payment sender computer application; (5) wirelessly receiving, by the payment recipient computer application and from the payment sender computer application, payment information; and (6) executing, by the payment recipient computer application, the payment using the payment information.

In one embodiment, the method may also include receiving, by the payment recipient computer application, an identification of the payment sender.

In one embodiment, the method may also include communicating, by the payment recipient computer application, a reason for the payment to the payment sender computer application.

In one embodiment, the payment sender computer application may be configured to verify the requested payment amount before communicating the payment information to the payment recipient computer application.

In one embodiment, the payment information may include a payment sender token.

In one embodiment, the payment recipient computer application executes a tokenized payment using the payment sender token.

In one embodiment, the payment information may include a debit card identifier, and the payment recipient computer application executes the payment using a debit network.

According to another embodiment, a system may include a payment receiving mobile device for a payment recipient executing a payment recipient computer application and a payment sending mobile device for a payment sender executing a payment sender computer application. The payment recipient computer application receives a requested payment amount for a payment from the payment recipient, causes the payment receiving mobile device to enter a listening mode, receives a communication from the payment sender computer application, and wirelessly communicates the requested payment amount to the payment sender computer application. In response to the communication of the requested payment amount, the payment sender computer application wirelessly communicates payment information to the payment recipient computer application. The payment recipient computer application executes the payment using the payment information.

In one embodiment, the payment recipient computer application receives an identification of the payment sender.

In one embodiment, the payment recipient computer application communicates a reason for the payment to the payment sender computer application.

In one embodiment, the payment sender computer application verifies the requested payment amount before communicating the payment information to the payment recipient computer application.

In one embodiment, the payment information may include a payment sender token.

In one embodiment, the payment recipient computer application executes a tokenized payment using the payment sender token.

In one embodiment, the payment information may include a debit card identifier, and the payment recipient computer application executes the payment using a debit network.

According to another embodiment, a non-transitory computer readable storage medium, including instructions stored thereon, which when read and executed by one or more computer processors, cause the one or more computer processors to perform steps comprising: receiving a requested payment amount for a payment from a payment recipient from a payment sender; causing the payment receiving mobile device to enter a listening mode; receiving a communication from a payment sender computer application executed by a payment sending mobile device; wirelessly communicating the requested payment amount to the payment sender computer application; wirelessly receiving, from the payment sender computer application, payment information; and executing the payment using the payment information.

In one embodiment, the non-transitory computer readable storage medium may also include instructions stored thereon, which when read and executed by one or more computer processors, cause the one or more computer processors to perform steps comprising: receiving an identification of the payment sender.

In one embodiment, the non-transitory computer readable storage medium may also include communicating to the sender computer application a reason for the payment to the payment sender computer application.

In one embodiment, the payment sender computer application may be configured to verify the requested payment amount before communicating the payment information to the payment recipient computer application.

In one embodiment, the payment information may include a payment sender token, and the payment may be executed as a tokenized payment using the payment sender token.

In one embodiment, the payment information may include a debit card identifier, and the payment recipient computer application executes the payment using a debit network.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for proximity-based mobile device person-to-person payments according to an embodiment.

FIG. 2 depicts a method for proximity-based mobile device person-to-person payments according to an embodiment.

FIG. 3 depicts an exemplary computing system for implementing aspects of the present disclosure.

### DETAILED DESCRIPTION OF PREFERRED EMBODIMENTS

Embodiments are directed to systems and methods for proximity-based mobile device person-to-person payments.

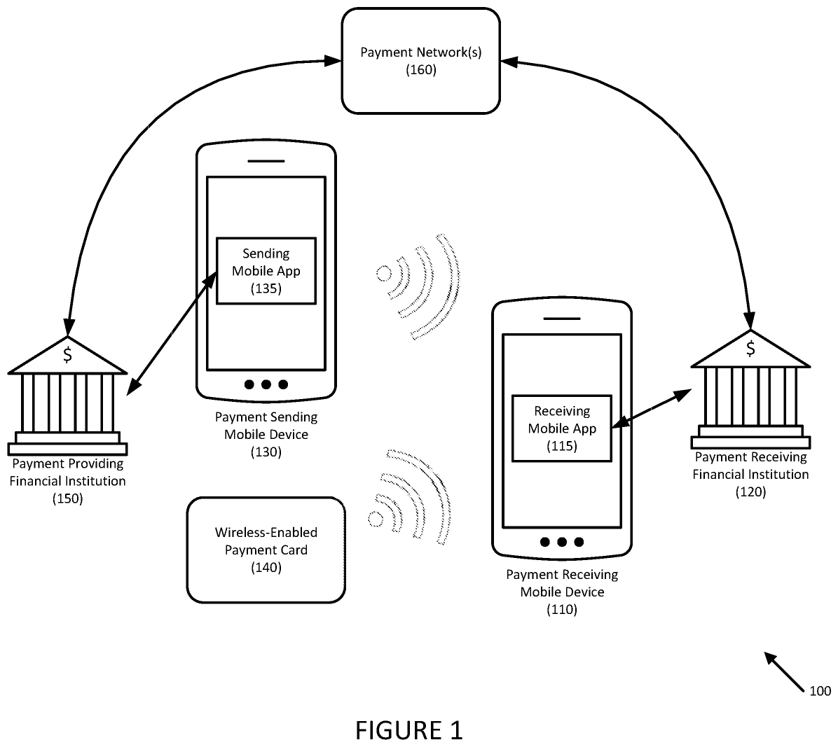

Referring to FIG. 1, a system for proximity-based mobile device person-to-person payments is disclosed according to an embodiment. System 100 may include payment receiving mobile device 110, which may be any suitable mobile device that offers the ability to receive proximity-based payments, such as Near Field Communication (NFC) payments, WiFi payments, Bluetooth payments, etc. Examples of payment receiving mobile device 110 include computers (e.g., desktops, laptops, notebooks, tablets, etc.), smart phones, smart watches, etc. Payment receiving mobile device 110 may execute receiving mobile application 115, which may be a mobile wallet, a payment application, a bank application, etc. In one embodiment, receiving mobile application 115 may be integrated into an operating system of payment receiving mobile device 110.

Receiving mobile application 115 may be linked to, or associated with, an account at payment receiving financial institution 120, which may be a bank, a FinTech, etc. In one embodiment, the account may be a demand deposit account (DDA), a credit account, etc.

System 100 may further include payment sending mobile device 130 and wireless-enabled payment card 140. Payment sending mobile device 130 may be any suitable device that offers the ability to send proximity-based payments. Examples include computers, smart phones, smart watches, etc.

Payment sending mobile device 130 may execute sending mobile application 135, which may be a mobile wallet, a payment application, a bank application, etc. In one embodiment, sending mobile application 135 may be integrated into an operating system of payment sending mobile device 130.

Wireless-enabled payment card 140 may be any suitable payment instrument that may provide wireless payment capability, such as payment by “tapping” the card to a point of sale device or similar device. In one embodiment, wireless-enabled payment card 140 may include a display (not shown) or other mechanism for communicating information with the payment sender.

Sending mobile application 135 and/or wireless-enabled payment card 140 may be linked to, or associated with, an account at payment sending financial institution 150, which may be a bank, a FinTech, etc. In one embodiment, the account may be a DDA, a credit account, etc.

In one embodiment, the linking of accounts with receiving mobile application 115 and/or sending mobile application 135 may facilitate the presentation of other information from a respective financial institution 120 or 150 by receiving mobile application 115 and/or sending mobile application 135. For example, credit score information, offers for other financial products, etc. may be delivered and presented via this linking.

In one embodiment, sending mobile application 135 and receiving mobile application 115 may be the same mobile application that may operate in different modes. For example, sending mobile application 135 may be a mobile application in which the user has selected a send payment option, and receiving mobile application 115 may be a mobile application that the user has selected a receive payment option.

Payment sending financial institution 150 and payment receiving financial institution 120 may transact over one or more payment networks 160. Payment network(s) 160 may be any suitable payment network, including debit networks (e.g., VISA or MASTERCARD debit networks), credit card networks (e.g., VISA, MASTERCARD, AMERICAN EXPRESS), the Automated Clearing House (ACH), the Early Warning Services (EWS) payment network, The Clearing House (TCH) payment network, the SWIFT network, bank wire networks, etc. In one embodiment, the payment network 160 that is used may depend on whether the payment is a tokenized payment, whether the payment is a debit payment, and/or whether the payment is a credit card payment.

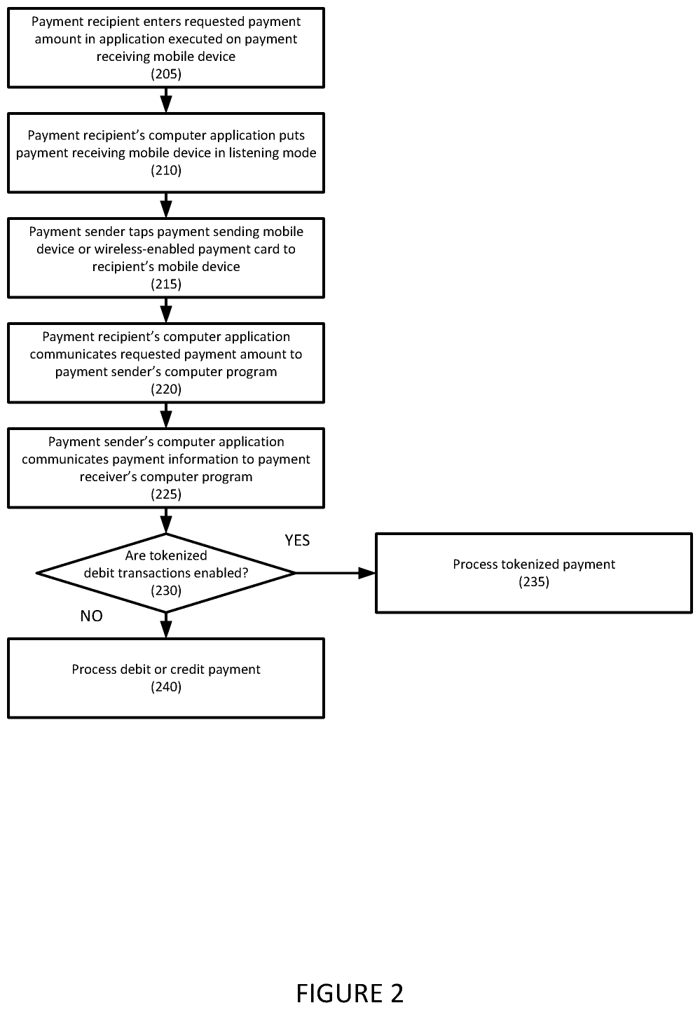

Referring to FIG. 2, a method for proximity-based mobile device person-to-person payments is disclosed according to an embodiment.

In step 205, a payment recipient may enter a requested payment amount in a payment recipient computer application executed on a payment receiving mobile device. In one embodiment, the payment recipient may also identify the payment sender, if known.

In step 210, the payment recipient computer application may cause the payment receiving mobile device to go into listening mode. For example, the payment recipient computer application may cause the operating system for the payment receiving mobile device to enable a transceiver, such as a NFC transceiver, a Bluetooth transceiver, etc. Once the payment is requested, the payment receiving mobile device may place its wireless radio into “listen” mode for wireless communications (e.g., NFC, WiFi, Bluetooth, etc.). The radio may remain in listen mode for a certain period of time.

In step 215, the payment sender may tap the payment sending mobile device or a wireless-enabled payment card to the payment receiving mobile device, or bring the payment sending mobile device or a wireless-enabled payment card within a certain distance of the payment receiving mobile device. In one embodiment, the payment sending mobile device or a wireless-enabled payment card may be detected by the payment receiving mobile device when it is within the predetermined distance.

In one embodiment, the payment sending mobile device or a wireless-enabled payment card may initiate communication with the payment receiving mobile device.

In step 220, the payment recipient computer application may communicate the requested amount to the payment sender computer application. Additional information, such reason for the request (e.g., an identification of a good or service provided, a memo for the payment, etc.), a request for the sender token (e.g., a Zelle token), etc. may be communicated as is necessary and/or desired.

In step 225, the payment sending mobile device or the wireless-enabled payment card may then communicate the payment information to the payment receiving mobile device wirelessly, such as by NFC, WiFi, Bluetooth, etc. In one embodiment, the payment sending mobile device may communicate an identifier, such as a debit card number, which may be used as a token for a payment, such as a Zelle payment.

Optionally, the payment sender computer application may prompt the payment sender to verify the amount requested by the payment recipient. The payment sender may verify and authorize transmission of payment amount to the payment recipient.

In step 230, the payment recipient computer application may determine whether tokenized debit transactions have been enabled and are available. If they are, in step 235, the payment recipient computer application may process the payment as a tokenized payment using the payment sender's token over a payment network such as those provided by Early Warning Services, LLC (EWS) and The Clearing House (TCH), etc.

If tokenized payments are not enabled or are not available, in step 240, the payment recipient computer application may process the payment as, for example, a debit or credit payment.

In embodiments, payments may be authenticated before being requested and/or before being sent. For example, requests for payments may be authenticated before the payment receiving mobile device is configured to receive a payment, and/or the payment sending device may authenticate payments before they are sent. The authentication may be at the respective mobile device, by the mobile application on the mobile device, using out of band communication, etc. Thus, embodiments may prevent unauthorized or fraudulent payments from being sent and/or requested (e.g., if a bad actor was able to access a payment sending mobile device, it cannot be sent).

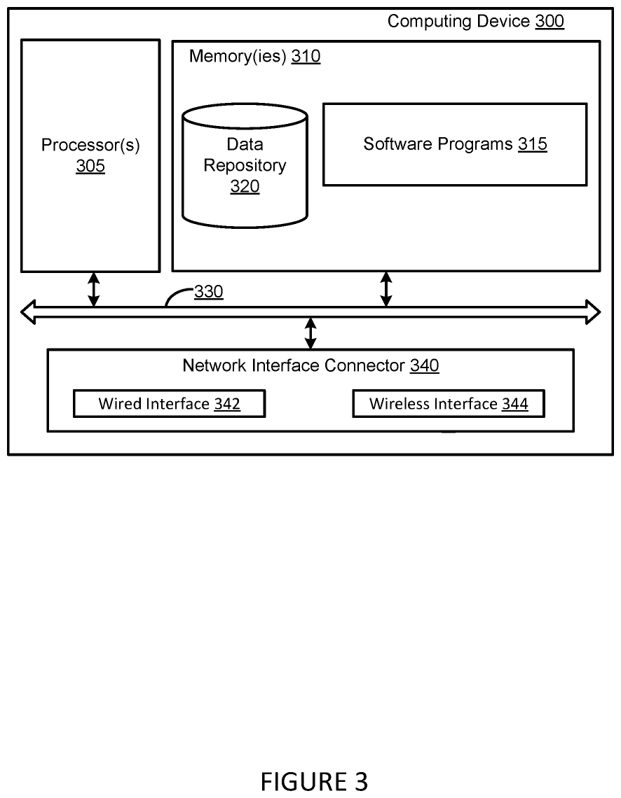

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while embodiments present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for proximity-based mobile device person-to-person payments, comprising:
receiving, at a payment recipient computer application executed on a payment receiving mobile device, a requested payment amount for a payment from a payment recipient from a payment sender;
causing, by the payment recipient computer application, the payment receiving mobile device to enter a listening mode;
receiving, by the payment recipient computer application, a communication from a payment sender computer application executed by a payment sending mobile device;
wirelessly communicating, by the payment recipient computer application, the requested payment amount to the payment sender computer application;
wirelessly receiving, by the payment recipient computer application and from the payment sender computer application, payment information; and
executing, by the payment recipient computer application, the payment using the payment information.

2. The method of claim 1, further comprising:
receiving, by the payment recipient computer application, an identification of the payment sender.

3. The method of claim 1, further comprising:
communicating, by the payment recipient computer application, a reason for the payment to the payment sender computer application.

4. The method of claim 1, wherein the payment sender computer application is configured to verify the requested payment amount before communicating the payment information to the payment recipient computer application.

5. The method of claim 1, wherein the payment information comprises a payment sender token.

6. The method of claim 5, wherein the payment recipient computer application executes a tokenized payment using the payment sender token.

7. The method of claim 1, wherein the payment information comprises a debit card identifier, and the payment recipient computer application executes the payment using a debit network.

8. A system, comprising:
a payment receiving mobile device for a payment recipient executing a payment recipient computer application; and
a payment sending mobile device for a payment sender executing a payment sender computer application;
wherein:
the payment recipient computer application receives a requested payment amount for a payment from the payment recipient;
the payment recipient computer application causes the payment receiving mobile device to enter a listening mode;
the payment recipient computer application receives a communication from the payment sender computer application;
the payment recipient computer application wirelessly communicates the requested payment amount to the payment sender computer application;
in response to the communication of the requested payment amount, the payment sender computer application wirelessly communicates payment information to the payment recipient computer application; and
the payment recipient computer application executes the payment using the payment information.

9. The system of claim 8, wherein the payment recipient computer application receives an identification of the payment sender.

10. The system of claim 8, wherein the payment recipient computer application communicates a reason for the payment to the payment sender computer application.

11. The system of claim 8, wherein the payment sender computer application verifies the requested payment amount before communicating the payment information to the payment recipient computer application.

12. The system of claim 8, wherein the payment information comprises a payment sender token.

13. The system of claim 12, wherein the payment recipient computer application executes a tokenized payment using the payment sender token.

14. The system of claim 8, wherein the payment information comprises a debit card identifier, and the payment recipient computer application executes the payment using a debit network.

15. A non-transitory computer readable storage medium, including instructions stored thereon, which when read and executed by one or more computer processors, cause the one or more computer processors to perform steps comprising:
receiving a requested payment amount for a payment from a payment recipient from a payment sender;
causing the payment receiving mobile device to enter a listening mode;
receiving a communication from a payment sender computer application executed by a payment sending mobile device;
wirelessly communicating the requested payment amount to the payment sender computer application;
wirelessly receiving, from the payment sender computer application, payment information; and
executing the payment using the payment information.

16. The non-transitory computer readable storage medium of claim 15, further including instructions stored thereon, which when read and executed by one or more computer processors, cause the one or more computer processors to perform steps comprising:
receiving an identification of the payment sender.

17. The non-transitory computer readable storage medium of claim 15, further including instructions stored thereon, which when read and executed by one or more computer processors, cause the one or more computer processors to perform steps comprising:
communicating to the sender computer application a reason for the payment to the payment sender computer application.

18. The non-transitory computer readable storage medium of claim 15, wherein the payment sender computer application is configured to verify the requested payment amount before communicating the payment information to the payment recipient computer application.

19. The non-transitory computer readable storage medium of claim 15, wherein the payment information comprises a payment sender token, and the payment is executed as a tokenized payment using the payment sender token.

20. The non-transitory computer readable storage medium of claim 15, wherein the payment information comprises a debit card identifier, and the payment recipient computer application executes the payment using a debit network.
